(19) United States
(12) Patent Application Publication
(10) Pub. No.: US 2026/0326198 A1
(43) Pub. Date: Oct. 22, 2026

(54) PRODUCTION METHOD FOR SLIGHTLY OXIDIZED COPPER-CONTAINING PARTICLES, AND SLIGHTLY OXIDIZED COPPER-COATED COPPER PARTICLES

(71) Applicant: NATIONAL UNIVERSITY CORPORATION HOKKAIDO UNIVERSITY, Sapporoshi, Hokkaido (JP)

(72) Inventors: Tetsu YONEZAWA, Sapporo-shi, Hokkaido (JP); Hiroki TSUKAMOTO, Sapporo-shi, Hokkaido (JP)

(21) Appl. No.: 19/105,942

(22) PCT Filed: Aug. 30, 2023
(86) PCT No.: PCT/JP2023/031573

§ 371 Date: Feb. 24, 2025

(30) Foreign Application Priority Data
Sep. 2, 2022 (JP) 2022-140366
Feb. 9, 2023 (JP) 2023-018736

(51) Int. Cl. B22F 1/145; B22F 1/16; B23K 35/02; B23K 35/30; C09D 11/037; C09D 11/52

(52) U.S. Cl. CPC B22F 1/145; B22F 1/16; B23K 35/025; B23K 35/302; C09D 11/037; C09D 11/52; B22F 2301/10; B22F 2302/25; B22F 2999/00

(57) ABSTRACT

A production method for slightly oxidized copper-containing particles having, at least on surfaces thereof, slightly oxidized copper composed of one or more of Cu₆₄O and Cu₈O, the method comprising:
preparing raw material particles having, at least on a surface thereof, a copper oxide including one or more of CuO and Cu₂O; and
mixing the raw material particles with a solution containing an amine compound and a complexing agent, then adding a reducing agent, and allowing the resultant to react in an oxygen-containing atmosphere.

### CROSS REFERENCE TO RELATED APPLICATIONS

This is the U.S. national stage of application No. PCT/JP2023/031573, filed Aug. 30, 2023. Priority under 35 U.S.C. § 119(a) and 35 U.S.C. § 365(b) is claimed from Japanese Application No. 2022-140366 filed Sep. 2, 2022, and Japanese Application No. 2023-018736 filed Feb. 9, 2023, the disclosure of which is also incorporated herein by reference.

### TECHNICAL FIELD

The present disclosure relates to a production method for slightly oxidized copper-containing particles, and to slightly oxidized copper-coated copper particles.

### BACKGROUND ART

In recent years, in the manufacture of printed circuit boards, as a clean technique that requires neither exposure to light nor etching, which have been conventionally used, and does not emit harmful chemical substances, a technique called printable electronics that directly forms fine wiring by inkjet or printing has attracted attention.

The fine wiring is mainly obtained by heating and sintering metal fine particles. The metal fine particles are required to be sintered, for example, at a low temperature of 150° C. or lower from the viewpoint of heat resistance of the base material or the like. At present, silver fine particles, which can be sintered at a low temperature, are often used, but silver fine particles are expensive and there is a concern about the influence of a wiring short circuit due to ion migration. As a substitute for silver fine particles, copper fine particles, which are inexpensive and have high resistance to ion migration, have attracted attention, but copper fine particles have a problem that it is difficult to sinter them at a low temperature.

As a measure to the above problems, the present inventors have attempted to obtain low-temperature sintering particles using an oxide of copper. As an oxide of copper, five types, namely, CuO, Cu₂O, Cu₄O₃, Cu₈O, and Cu₆₄O, are known. Among them, Cu₆₄O and Cu₈O have a smaller proportion of oxygen atoms, are lower in stability, and can be reduced to metal copper with lower energy as compared with CuO and Cu₂O, which are stable phases. Therefore, it is conceivable to realize low-temperature sintering at 150° C. or lower by using Cu₆₄O or Cu₈O. In the present description, Cu₆₄O and Cu₈O, which have a small proportion of oxygen atoms, are particularly referred to as “slightly oxidized copper”, and are distinguished from other oxides, namely, CuO, Cu₂O, and Cu₄O₃.

For example, Patent Document 1 discloses a copper oxide-containing copper fine particles comprising Cu₆₄O and optionally Cu₂O and coated with a carboxylic acid, wherein a mass ratio of Cu₆₄O to a total mass of Cu, Cu₆₄O and Cu₂O is 0.5 to 2.0% by mass.

In recent years, electrical components are required to have further enhanced electrical conductivity, and as a conductive material technology utilizing not only submicron oxide-containing copper fine particles, whose surface necking characteristics are improved by the carboxylic acid film described in Patent Document 1, but also nano-sized melting point drop, the following Patent Documents 2 and 3 can be cited. Patent Document 2 discloses a copper oxide particle composition containing at least one of Cu₆₄O particles and Cu₈O particles, in which at least one of the Cu₆₄O particles and the Cu₈O particles has an average particle diameter of 20 nm or less. Patent Document 3 discloses mixed particles containing copper clusters having an average particle diameter of 0.1 nm or more and 1 nm or less and copper oxide particles having an average particle diameter of more than 1 nm and not more than 20 nm, wherein the copper oxide particles are at least one of Cu₆₄O particles and the Cu₈O particles. Patent Document 3 also discloses mixed particles containing copper clusters having an average particle diameter of 0.1 nm or more and 1 nm or less, copper oxide particles having an average particle diameter of more than 1 nm and not more than 20 nm, and metal copper particles having an average particle diameter of more than 20 nm and not more than 1 μm, wherein the copper oxide particles are at least one of Cu₆₄O particles and the Cu₈O particles.

### PRIOR ART DOCUMENT

### Patent Document

Patent Document 1: WO 2022/045252
Patent Document 2: JP-A-2020-29392
Patent Document 3: JP-A-2020-100893

### SUMMARY OF THE INVENTION

### Technical Problems

In Patent Documents 2 and 3, a copper salt such as copper acetate is used as a starting material for the production of copper oxide particles contained in mixed particles, but the copper salt is bulky and heavy, and it takes a long time for a reaction step including dissolution of the copper salt in a solvent. In addition, although a concentration of copper ions is high at the initial stage of reduction, the concentration changes during the reaction process. Then, it is difficult to control the reaction and control the resulting particle size particularly in a concentrated system. Therefore, it is considered that further investigations are necessary for industrial mass production. In addition, in the resulting mixed particles, metal copper particles and fine copper oxide particles are each easily aggregated, and it is difficult to obtain a state in which these particles are mutually dispersed. The present disclosure has been made in view of the above circumstances, and an object thereof is to provide a method for producing with high mass productivity slightly oxidized copper-containing particles having, at least on the surfaces thereof, slightly oxidized copper composed of one or more of Cu₆₄O and Cu₈O useful for sintering at a low temperature.

### Solution to Problems

Aspect 1 of the present invention is a production method for slightly oxidized copper-containing particles having, at least on surfaces thereof, slightly oxidized copper composed of one or more of Cu₆₄O and Cu₈O, the method comprising:
preparing raw material particles having, at least on a surface thereof, a copper oxide including one or more of CuO and Cu₂O; and
mixing the raw material particles with a solution containing an amine compound and a complexing agent, then adding a reducing agent, and allowing the resultant to react in an oxygen-containing atmosphere.

Aspect 2 of the present invention is
the production method according to Aspect 1, wherein the raw material particles are raw material particles made of a copper oxide including one or more of CuO and Cu₂O.

Aspect 3 of the present invention is
the production method according to Aspect 1, wherein the raw material particles are copper oxide-coated copper raw material particles each having a copper raw material particle as a core and a copper oxide film containing one or more of CuO and Cu₂O as a shell.

Aspect 4 of the present invention is
the production method according to any one of Aspects 1 to 3, wherein the copper oxide contained in the raw material particles is Cu₂O.

Aspect 5 of the present invention is
the production method according to any one of Aspects 1 to 4, wherein the complexing agent is a carboxylic acid.

Aspect 6 of the present invention is
the production method according to any one of Aspects 1 to 5, wherein the complexing agent is a carboxylic acid.

Aspect 7 of the present invention is
the production method according to any one of Aspects 1 to 6, wherein the reaction is performed at 50° C. or lower.

Aspect 8 of the present invention relates to:
the production method according to any one of Aspects 1 to 7, wherein the raw material particles have an average particle diameter of more than 20 nm and not more than 10 μm.

Aspect 9 of the present invention is
slightly oxidized copper-coated copper particles each comprising: a copper particle as a core; and a shell including slightly oxidized copper composed of one or more of Cu₆₄O and Cu₈O.

Aspect 10 of the present invention is
the slightly oxidized copper-coated copper particles according to Aspect 9, wherein the slightly oxidized copper composed of one or more of Cu₆₄O and Cu₈O are in the form of slightly oxidized copper particles having an average particle diameter of more than 1 nm and not more than 20 nm.

Aspect 11 of the present invention is
the slightly oxidized copper-coated copper particles according to Aspect 9 or 10, wherein the copper particles as cores have an average particle diameter of more than 20 nm and not more than 2 μm.

Aspect 12 of the present invention is
a bonding material comprising the slightly oxidized copper-coated copper particles according to any one of Aspect 9 to 11.

### Advantageous Effects of Invention

According to the present disclosure, it is possible to provide a method for producing with high mass productivity slightly oxidized copper-containing particles having, at least on surfaces thereof, slightly oxidized copper composed of one or more of Cu₆₄O and Cu₈O useful for sintering at a low temperature.

### BRIEF DESCRIPTION OF THE DRAWINGS

FIG. 1 shows XRD patterns in the reaction processes of Examples 1 to 3.

FIG. 2 shows XRD patterns in the reaction processes of Comparative Examples 1 to 3.

FIG. 3 shows XRD patterns in the reaction processes of Comparative Examples 4 to 6.

FIG. 4A to FIG. 4C show TEM images of particles obtained in Examples 1 to 3.

FIG. 5 is a STEM image of particles obtained in Example 1 (starting material: Cu₂O).

FIG. 6 is a STEM image of particles obtained in Example 2 (starting material: CuO).

FIG. 7 shows XRD patterns in the reaction processes of Examples 4 to 6.

FIG. 8 shows XRD patterns in the reaction processes of Examples 7 and 8 and Comparative Example 7.

FIG. 9A and FIG. 9B show SEM images of the starting material of Example 4 and particles after the reaction for 24 hours.

FIG. 10 shows a TEM image of particles obtained in Example 4.

FIG. 11 shows STEM images of particles obtained in Example 4, and the STEM images on the right side are enlarged images of the respective lattice spacings shown in the STEM image on the left side.

FIG. 12A and FIG. 12B show SEM images of the starting material of Example 5 and particles after the reaction for 24 hours.

FIG. 13 shows a TEM image of particles obtained in Example 5.

FIG. 14 shows a TEM image of particles obtained in Example 6.

FIG. 15A and FIG. 15B show SEM images of the starting material of Example 7 and particles after the reaction for 24 hours.

FIG. 16 shows a TEM image of particles obtained in Example 7.

FIG. 17A and FIG. 17B show SEM images of the starting material of Example 8 and particles after the reaction for 24 hours.

FIG. 18 illustrates TG-DTA measurement results in Example 4A.

FIG. 19 is a diagram showing a preparation procedure of a sample for evaluation of bonding calcination in Example 4A.

FIG. 20A is a schematic view of a copper test piece used for the preparation of a sample for evaluation of bonding calcination in Example 4A.

FIG. 20B is a schematic view of a metal mask used for the preparation of a sample for evaluation of bonding calcination in Example 4A.

FIG. 20C is a schematic view illustrating hot pressing in the bonding calcination evaluation test in Example 4A.

FIG. 20D is a schematic sectional view illustrating the method of the bonding calcination evaluation test in Example 4A.

FIG. 21 is a diagram showing the result of the bonding calcination evaluation test in Example 4A.

FIG. 22 is a SEM image observing a fracture surface after the bonding calcination evaluation test in Example 4A.

FIG. 23 is a temperature profile in hot pressing when the bonding time is 1 minute in Example 4A.

FIG. 24 is a diagram showing the result of the conductivity evaluation in Example 4A.

FIG. 25 shows XRD patterns before and after the calcination of a paste in the conductivity evaluation in Example 4A.

FIG. 26 is a SEM image of the calcined product in the conductivity evaluation in Example 4A.

FIG. 27 is an XRD pattern in the reaction process of Example 9.

FIG. 28A and FIG. 28B show SEM images of the starting material of Example 9 and particles after the reaction for 24 hours.

FIG. 29 shows a TEM image of particles obtained in Example 9.

### DESCRIPTION OF EMBODIMENTS

The present inventors have extensively conducted studies for realizing a method for producing with good mass productivity slightly oxidized copper-containing particles having, at least on surfaces thereof, slightly oxidized copper composed of one or more of Cu₆₄O and Cu₈O useful for sintering at a low temperature. As a result, the present inventors have found that it is important to prepare raw material particles having, at least on a surface thereof, copper oxides including one or more of CuO and Cu₂O, and to mix the raw material particles with a solution containing a complexing agent in a production process. In addition, the present inventors have found slightly oxidized copper-coated copper particles each having a copper particle as a core and a shell including slightly oxidized copper composed of one or more of Cu₆₄O and Cu₈O. Hereinafter, first, the production method according to the present embodiment will be described in detail.

[Method for Producing Slightly Oxidized Copper-Containing Particles Having, at Least on the Surfaces Thereof, Slightly Oxidized Copper Composed of One or More of Cu₆₄O and Cu₈O]

The method for producing slightly oxidized copper-containing particles having, at least on surfaces thereof, slightly oxidized copper composed of one or more of Cu₆₄O and Cu₈O according to the present embodiment includes:
preparing raw material particles having, at least on a surface thereof, a copper oxide including one or more of CuO and Cu₂O; and
mixing the raw material particles with a solution containing an amine compound and a complexing agent, then adding a reducing agent, and allowing the resultant to react in an oxygen-containing atmosphere.

The production method according to the present embodiment is divided into the following first production method and second production method depending on the form of the raw material particles.

The first production method is a method for producing slightly oxidized copper-containing particles including slightly oxidized copper composed of one or more of Cu₆₄O and Cu₈O, the method including: preparing particles made of copper oxide including one or more of CuO and Cu₂O as raw material particles; mixing the raw material particles with a solution containing an amine compound and a complexing agent; and then adding a reducing agent and allowing the resultant to react.

The second production method is a method for producing core-shell type slightly oxidized copper-coated copper particles each having a copper particle as a core and a shell including slightly oxidized copper composed of one or more of Cu₆₄O and Cu₈O, the method including: preparing, as raw material particles, copper oxide-coated copper raw material particles each having a copper raw material particle as a core and a copper oxide film including one or more of CuO and Cu₂O as a shell, mixing the raw material particles with a solution containing an amine compound and a complexing agent, and subsequently adding a reducing agent and allowing the resultant to react.

Hereinafter, the conditions of the production method according to the present embodiment will be described in detail.

### [Step of Preparing Raw Material Particles]

First, raw material particles having, at least on a surface thereof, a copper oxide containing one or more of CuO and Cu₂O are prepared. In the first production method, raw material particles made of a copper oxide containing one or more of CuO and Cu₂O are prepared as the aforementioned raw material particles. The raw material particles may be copper oxide raw material particles composed of one or more of CuO and Cu₂O. The raw material particles of the first production method are preferably copper oxide raw material particles made of Cu₂O.

In the second production method, as the aforementioned raw material particles, copper oxide-coated copper raw material particles each having a copper raw material particle as a core and a copper oxide film containing one or more of CuO and Cu₂O as a shell are prepared. The particles are preferably core-shell type copper oxide-coated copper raw material particles each having a copper raw material particle as a core and coated with preferably a copper oxide composed of one or more of CuO and Cu₂O, more preferably a copper oxide made of Cu₂O.

As the copper oxide-coated copper raw material particles which are the raw material particles of the second production method, a commercially available product may be used. Alternatively, particles having a surface oxide film formed by natural oxidation of copper particles may be used, or particles having a surface oxide film formed by subjecting the surface of copper particles to an oxidation treatment may be used. Alternatively, copper oxide-coated copper raw material particles obtained by, for example, supplying a copper oxide containing one or more of CuO and Cu₂O (for example, a copper oxide in a powdery form) to the surfaces of copper raw material particles with no or almost no copper oxide formed on the surfaces thereof by adding the copper oxide to a dispersion containing the copper raw material particles or applying the copper oxide to the surfaces of the copper raw material particles may be used. The surface oxide film formed by natural oxidation is formed due only to the fact that metal copper particles are present in air. Therefore, it is considered that the commercially available metal copper particles also have been naturally oxidized by being present in the air, and the particles on which a surface oxide film is formed by natural oxidation of the copper particles, which are the raw material particles of the second production method, also include commercially available metal copper particles.

In the production method of the present embodiment, the size of the raw material particles is not limited. In the case of the first production method, the raw material particles made of a copper oxide containing one or more of CuO and Cu₂O may have an average particle diameter of, for example, 20 nm to 10 μm. From the viewpoint of inhibiting CuO and Cu₂O from remaining as residues by sufficient reduction in the reaction step, the average particle diameter of the raw material particles of the first production method is preferably 10 μm or less as described above. In the case of the second production method, the copper raw material particles as cores may have an average particle diameter of, for example, 20 nm to 2 μm. In addition, the copper oxide film containing one or more of CuO and Cu₂O present on the surface of each copper raw material particle as a core may have a thickness of 20 nm or less. In the present description, the “particle size” refers to a primary particle size and a circle equivalent diameter, and the “average particle diameter” refers to a median diameter of 150 or more particles randomly selected from a SEM image or a TEM image.

In the second production method, as the copper oxide film containing one or more of CuO and Cu₂O (preferably, a copper oxide film made of Cu₂O) present on the surface of the raw material particle, an oxide film with a degree of natural oxidation undetectable by X-ray diffraction is sufficient. The copper oxide film of the raw material particles may be more than the natural oxide film. For example, the proportion of the copper oxide containing one or more of CuO and Cu₂O accounting for in the raw material particles may be 1% by mass or more. When it is desired to form a thick shell including slightly oxidized copper composed of one or more of Cu₆₄O and Cu₈O in the core-shell type slightly oxidized copper-coated copper particles to be finally obtained, it is permitted to actively oxidize the raw material particles. In that case, if the amount of the copper oxide on the surface accounting for in the raw material particles is excessively large, the shell including slightly oxidized copper composed of one or more of Cu₆₄O and Cu₈O is less likely to adhere to the copper particle as the core. In addition, the shell including slightly oxidized copper composed of one or more of Cu₆₄O and Cu₈O has lower crystallinity when sintered at a low temperature as compared with core copper particles having high crystallinity, and thus there is a concern that the mechanical strength and electrical conductivity are deteriorated when the shell is thick. From these viewpoints, the proportion of the copper oxide containing one or more of CuO and Cu₂O accounting for in the raw material particles is preferably 10% by mass or less.

### [Reaction Step]

The raw material particles are mixed with a solution containing an amine compound and a complexing agent, and then a reducing agent is added, and the resultant is allowed to react. Hereinafter, a complexing agent and the like which are necessary for the reaction as stated above will be described.

### [Complexing Agent]

In the present embodiment, the copper oxide contained in the raw material particles is allowed to react with a complexing agent to form complex ions of copper. As described above, by ionizing copper in the raw material particles, the rate of reduction by a reducing agent can be made significantly greater than that of reduction of a solid copper oxide. Examples of the complexing agent include carboxylic acids. Examples of the carboxylic acids include formic acid, saturated fatty acids, unsaturated fatty acids, hydroxy acids, aromatic carboxylic acids, and terpene-based carboxylic acids. These may be monocarboxylic acids or dicarboxylic acids. These may be used singly or two or more thereof may be used in combination. The aliphatic monocarboxylic acid may be either linear or branched and may be either a saturated aliphatic monocarboxylic acid or an unsaturated aliphatic monocarboxylic acid. Examples of a linear saturated aliphatic monocarboxylic acid include acetic acid (two carbon atoms), propionic acid (three carbon atoms), butyric acid (four carbon atoms), valeric acid (five carbon atoms), and caproic acid (six carbon atoms).

The aliphatic dicarboxylic acid may be either linear or branched and may be either a saturated aliphatic dicarboxylic acid or an unsaturated aliphatic dicarboxylic acid. Aliphatic dicarboxylic acids may be used singly or two or more thereof may be used in combination. Examples of the aliphatic dicarboxylic acid include adipic acid, pimelic acid, suberic acid, azelaic acid, sebacic acid, 1,0-nonane dicarboxylic acid, 1,10-decane dicarboxylic acid, brasylic acid, 1,12-dodecane dicarboxylic acid, 1,13-tridecane dicarboxylic acid, thapsic acid, 1,15-pentadecane dicarboxylic acid, and 1,16-hexadecane dicarboxylic acid. Examples of the aromatic carboxylic acid include benzoic acid, phthalic acid, isophthalic acid, terephthalic acid, hemimellitic acid, trimellitic acid, and trimesic acid. As a terpene-based carboxylic acid, those contained in rosin and the like can be used. Examples thereof include abietic acid, neoabietic acid, parastrinic acid, pimaric acid, isopimaric acid, and desidroabietic acid.

Among them, it is preferable to use acetic acid, which is easy to handle and also easy to treat after the reaction.

The addition amount of the complexing agent to be used for the reaction is not particularly limited but is preferably 2 times or more and 15 times or less in terms of molar ratio with respect to the copper contained in the starting material particles from the viewpoint of promoting complex ion formation of copper in order to promote the generation of Cu₆₄O and Cu₈O.

### (Amine Compound)

A compound having an amino group (hereinafter, referred to as “amine compound”) is added as a protective agent. The amine compound also contributes to complex ion formation of copper. The amine compound is not particularly limited, and for example, an alkanolamine, a diamine, and an aminocarboxylic acid are preferably used. Among them, it is more preferable to use an alkanolamine. Examples of the alkanolamine include 2-amino-1-butanol, 1-amino-2-propanol, 2-amino-2-ethyl-1,3-propanediol, 2-amino-2-hydroxymethyl-1,3-propanediol, 1,3-diamino-2-propanol, 1-amino-2-butanol, and 2-aminoethanol.

The addition amount of the amine compound to be used for the reaction is not particularly limited, but from the viewpoint of promoting the generation of Cu₆₄O and Cu₈O, the molar ratio of the amine compound to the copper contained in the raw material particles is preferably 5 times or more. The molar ratio may be, for example, 20 times or less.

### (Solvent)

The solvent is not particularly limited, and for example, polyhydric alcohols such as ethylene glycol, lower alcohols such as methanol, ethanol, and 2-propanol, ketones such as acetone, and water can be used.

(Reducing agent)

The reducing agent is not particularly limited, and for example, hydrazine-based reducing agents such as hydrazine, hydrazine hydrochloride, hydrazine sulfate, and hydrazine hydrate, citric acid, ascorbic acids, and borohydrides such as sodium borohydride. The reducing agent may be added after the raw materials including the raw material particles, the complexing agent, the amine compound, and the solvent are added and mixed. After the addition of the reducing agent, stirring may be performed at least until the raw material particles disappear in the first production method, and stirring may be performed until formation of the desired slightly oxidized copper is confirmed in the second production method. In any production method, it is preferable that stirring is performed and the reaction is sufficiently performed until the reducing agent disappears.

### (Cooling During Reaction)

In the production method according to the present embodiment, for example, when hydrazine is used as the reducing agent, heat generation due to addition of the reducing agent, such as decomposition reaction of hydrazine, may occur, and the temperature of the reaction solution may rise. From the viewpoint of inhibiting the temperature rise of the reaction solution and inhibiting Cu₆₄O and Cu₈O once formed from being reduced into metallic copper, it is preferable to provide a temperature control means such as cooling the reaction solution such that the reaction proceeds at 50° C. or lower. For example, as shown in Examples described later, it is preferable to add a reducing agent while a reaction vessel is held in a water bath.

### (Atmosphere During Reaction)

In the production method according to the present embodiment, the atmosphere during the reaction is limited to an oxygen-containing atmosphere, such as air, and constantly exposed to the oxygen-containing atmosphere is necessary during the reaction. The case of an inert gas atmosphere such as nitrogen gas or argon gas, or the case of sealing the reaction vessel even in air is unfavorable because the oxide formation reaction into Cu₆₄O or Cu₈O does not proceed, and metal copper particles are formed.

### (Other Steps)

The production method of the present embodiment may further include a step other than the steps describe above, and may include, for example, a step of collecting slightly oxidized copper-containing particles by performing, for example, centrifugal separation or filtration on a slurry or the like containing particles having slightly oxidized copper composed of one or more of Cu₆₄O and Cu₈O obtained via the reduction described above, a subsequent purification step, drying step, or the like. In the purification step, it is preferable to perform the purification with a washing solvent. The washing solvent is not particularly limited, and for example, an organic solvent such as N, N-dimethylacetamide, toluene, or hexane can be used.

According to the first production method, as the slightly oxidized copper-containing particles having slightly oxidized copper composed of one or more of Cu₆₄O and Cu₈O, particularly, slightly oxidized copper particles composed of one or more of Cu₆₄O and Cu₈O can be obtained. The slightly oxidized copper-containing particles having slightly oxidized copper composed of one or more of Cu₆₄O and Cu₈O (preferably, slightly oxidized copper particles composed of one or more of Cu₆₄O and Cu₈O) obtained by the first production method may have an average particle diameter of more than 1 nm and not more than 20 nm. Further, the average particle diameter may be 15 nm or less and may be 10 nm or less.

According to the first production method, a slightly oxidized copper-containing particle composition in which copper clusters having an average particle diameter of 0.1 nm or more and 1 nm or less are present together with the slightly oxidized copper-containing particles can be obtained. The average particle diameter of the copper clusters may be 0.15 nm or more and 0.7 nm or less and may be 0.17 nm or more and 0.5 nm or less. Such a copper cluster is usually formed by assembling about 3 to 6 copper atoms. A copper cluster is an aggregate of an extremely small number of atoms as described above and has an extremely small particle size, and thus has a low melting point due to a nano-size effect. Therefore, such copper clusters have high sinterability.

In the present embodiment, it is confirmed by STEM observation that slightly oxidized copper composed of one or more of Cu₆₄O and Cu₈O are included in the slightly oxidized copper-containing particles obtained, as shown in Examples described later. The same applies to Cu₆₄O and Cu₈O contained in the slightly oxidized copper-coated copper particles described below.

### [Slightly Oxidized Copper-Coated Copper Particles]

The slightly oxidized copper-coated copper particles according to the present embodiment are slightly oxidized copper-coated copper particles each having a copper particle as a core and a shell including slightly oxidized copper composed of one or more of Cu₆₄O and Cu₈O. For example, as in the prior art, it has been difficult to uniformly disperse slightly oxidized copper particles, which are at least one of Cu₆₄O particles and Cu₈O particles, metal copper particles, and copper clusters in a composition containing them. In particular, when the slightly oxidized copper particles were fine particles having an average particle diameter of 20 nm or less, the fine particles were likely to aggregate and were difficult to disperse. In contrast, the slightly oxidized copper-coated copper particles according to the present embodiment have a core-shell structure in which slightly oxidized copper composed of one or more of Cu₆₄O and Cu₈O adhere to the surface of a metal copper particle as a core, for example, in the form of a coating film, and the problem regarding dispersion described above is solved. Furthermore, when the slightly oxidized copper-coated copper particles according to the present embodiment are sintered, sintering is promoted among slightly oxidized copper particles such as Cu₆₄O on the surfaces of metal copper particles, and a sintered compact that exhibits high electrical conductivity can be easily produced.

In the slightly oxidized copper-coated copper particles according to the present embodiment, the size of the copper particles constituting the cores is not limited, and for example, the average particle diameter thereof may be 20 nm to 2 μm. The average particle diameter may be more than 20 nm. The average particle diameter may be more than 2 μm, but for example, in the case of being used in printable electronics or the like, coarse particles may cause deterioration in printing quality, and therefore, the average particle diameter is preferably 2 μm or less.

The form of slightly oxidized copper composed of one or more of Cu₆₄O and Cu₈O forming the shell may be a film or a plurality of particulate matters. In the case of the plurality of particulate matters, the average particle diameter of the particulate matters may be, for example, 1 nm to 20 nm. The thickness of the shell (film thickness, or deposition thickness of the plurality of particulate matters) may be, for example, 1 to 20 nm. The shell including slightly oxidized copper composed of one or more of Cu₆₄O and Cu₈O is reduced to copper by sintering, but its crystallinity is not as high as that of the copper particle of the core. Therefore, an excessively thick shell invites concerns that the mechanical strength or electrical conductivity is deteriorated. From these viewpoints, the thickness of the shell is preferably 20 nm or less as described above.

In addition to the slightly oxidized copper composed of one or more of Cu₆₄O and Cu₈O, for example, copper oxides such as CuO and Cu₂O used as raw materials are allowed to be contained in the shell in a trace amount at a level at which sinterability or electrical conductivity is not inhibited. Preferably, copper oxides used as raw materials such as CuO and Cu₂O are not contained. The shell is preferably formed of a slightly oxidized copper composed of one or more of Cu₆₄O and Cu₈O, and more preferably formed of a slightly oxidized copper made of Cu₆₄O or composed of Cu₆₄O and Cu₈O.

The slightly oxidized copper-coated copper particles can be produced by the second production method described above, but the method to be used for this purpose is not limited thereto, and the slightly oxidized copper-coated copper particles may be produced by a method different from the second production method.

The slightly oxidized copper-coated copper particles according to the present embodiment have Cu₆₄O or Cu₈O on the surfaces thereof and have high sinterability. That is, when the slightly oxidized copper-coated copper particles according to the present embodiment are used, a sintered compact that has been sufficiently sintered can be obtained under normal pressure (or a pressure higher than that) at temperature of 250° C. or lower, or 200° C. or lower, or 150° C. or lower, or even at a relatively low of room temperature to 130° C. In addition, in the slightly oxidized copper-coated copper particles according to the present embodiment, the core portion is metal copper, and the content of copper oxides capable of increasing the resistance, such as CuO and Cu₂O, is held low, so that the slightly oxidized copper-coated copper particles can be sintered to obtain a sintered compact that exhibits high electrical conductivity.

Examples of the sintering material include a paste or ink containing the slightly oxidized copper-coated copper particles according to the present embodiment for the purpose of forming a conductive film or the like. Known materials may be used as the dispersion medium, the binder, and so on contained in the paste or ink.

The present disclosure also includes a bonding material including the slightly oxidized copper-coated copper particles according to the present embodiment. Examples of the bonding material include a paste or ink including the slightly oxidized copper-coated copper particles according to the present embodiment. Known materials may be used as the dispersion medium, the binder, and so on contained in the paste or ink. The bonding material including the slightly oxidized copper-coated copper particles according to the present embodiment is, for example, applied and bonded to a bonding surface of a plurality of materials, for example, metal (pure metal, alloy), ceramics, or the like, whereby a bonded body having high bonding strength can be obtained.

### EXAMPLES

In the following, the present invention will be described more specifically with reference to Examples. The present invention is not limited by the following Examples and can be implemented with appropriate modifications within the scope that can be consistent with the above-described and later-described gist, and all of them are included in the technical scope of the present invention.

### [1] Production Example According to First Production Method

In Examples 1 to 3, copper oxide fine particles were produced using the starting materials and so on shown in Table 1. Specifically, ethylene glycol (manufactured by Kanto Chemical Co., Inc.) as a solvent, 1-amino-2-propanol (AmIP, manufactured by Kanto Chemical Co., Inc.) as an amine compound, and acetic acid (manufactured by Junsei Chemical Co., Ltd.) as a complexing agent were placed in a reaction vessel, sufficiently stirred, and then copper (I) oxide (Cu₂O, manufactured by Furukawa Chemicals Co., Ltd., particle diameter: 0.5 to 10 μm) or copper (II) oxide (CuO, NB-2 manufactured by Nissin Chemco Ltd., particle diameter: 0.1 to 1 μm) was added as a starting material.

While the reaction vessel was held in a water bath, hydrazine monohydrate (manufactured by Kanto Chemical Co., Inc.) was added as a reducing agent, and the mixture was allowed to react while being stirred at 1100 rpm. The reaction was carried out in air. To confirm the difference between a lab scale and mass production, the reaction was performed at two levels of starting materials corresponding to 1 g of copper (Examples 1 and 2) and 100 g of copper (Example 3). The product obtained was purified by multiple centrifugations using N, N-dimethylacetamide, toluene, and hexane, obtaining a slurry containing the product.

As Comparative Examples, a slurry containing a product was obtained by performing a reaction in the same manner as in Examples except that copper (II) acetate, anhydrous (manufactured by FUJIFILM Wako Pure Chemical Corporation) was used as a starting material and the amount of the amine compound was changed in Comparative Examples 1 to 3, copper oxide was used as a starting material and a complexing agent was not added in Comparative Examples 4 and 5, and a reaction vessel was not cooled by a water bath in Comparative Example 6.

As shown in Table 1, it was separately confirmed that when the addition amount ratio (molar ratio) of the amine compound to copper was 5 times or more, rapid generation of the target Cu₆₄O and Cu₈O was confirmed, and the addition amount of the amine compound was set to 10 times in Examples 1 to 3.

TABLE 1

| | | | | | | | | | | Addition | |
|---|---|---|---|---|---|---|---|---|---|---|---|
| | | | | | | | | | | amount | Time |
| | | Addition amount | | | | | | | | ratio | required |
| | | Starting | | Acetic | | | | Ultimate | | amine/Cu | for |
| | Starting | material | AmIP | acid | Hydrazine | EG | Cooling | temperature | | (molar | reaction |
| No. | material | (mol) | (mol) | (mol) | (mol) | (mol) | method | (°C) | Main product | ratio) | (hr.) |
| Example 1 | Cu2O | 0.00787 | 0.1574 | 0.03148 | 0.1574 | 0.223508 | Water | <40 | Cu64O, Cu8O | 10 | 1 |
| | | | | | | | bath | | | | |
| Example 2 | CuO | 0.01574 | 0.1574 | 0.03148 | 0.1574 | 0.223508 | Water | <40 | Cu64O•Cu8O | 10 | 21 |
| | | | | | | | bath | | | | |
| Example 3 | Cu2O | 0.787 | 15.74 | 3.148 | 15.74 | 22.3508 | Water | 31.3 | Cu64O•Cu8O | 10 | 3 |
| | | | | | | | bath | | | | |
| Comparative | Cu(CH3COO)2 | 1.574 | 4.722 | 0 | 15.74 | 22.3508 | Water | 41.4 | Cu64O, Cu8O | 3 | 20 |
| Example 1 | | | | | | | bath | | | | |
| Comparative | Cu(CH3COO)2 | 1.574 | 7.87 | 0 | 15.74 | 22.3508 | Water | 42.2 | Cu64O, Cu8O | 5 | 3 |
| Example 2 | | | | | | | bath | | | | |
| Comparative | Cu(CH3COO)2 | 1.574 | 15.74 | 0 | 15.74 | 22.3508 | Water | 37.7 | Cu64O, Cu8O | 10 | 2 |
| Example 3 | | | | | | | bath | | | | |
| Comparative | Cu2O | 0.00787 | 0.1574 | 0 | 0.1574 | 0.223508 | Water | <40 | Cu | 10 | — |
| Example 4 | | | | | | | bath | | | | |
| Comparative | CuO | 0.01574 | 0.1574 | 0 | 0.1574 | 0.223508 | Water | <40 | Cu | 10 | — |
| Example 5 | | | | | | | bath | | | | |
| Comparative | Cu2O | 0.787 | 15.74 | 3.148 | 15.74 | 22.3508 | None | 53.8 | Cu | 10 | — |
| Example 6 | | | | | | | | | | | |

*EG: ethylene glycol,
AmIP: 1-amino-2-propanol

### (X-Ray Diffraction Measurement)

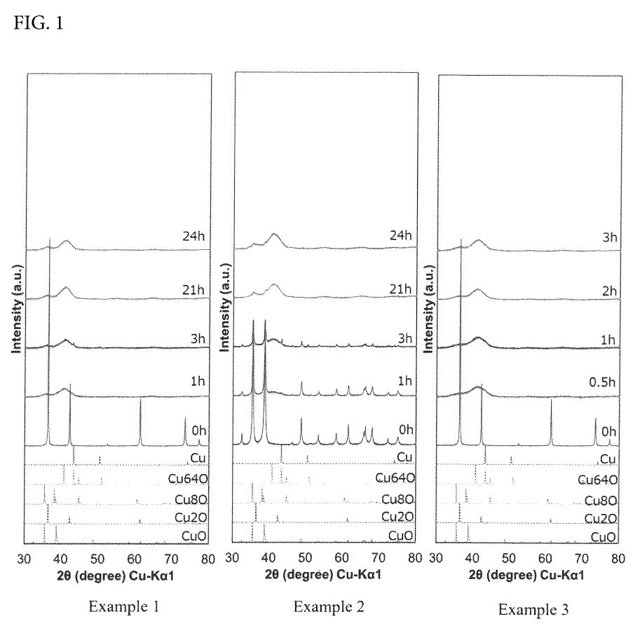

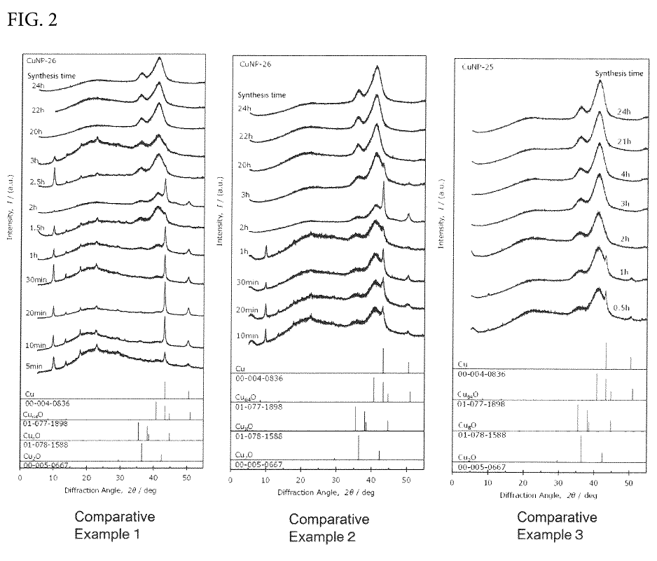

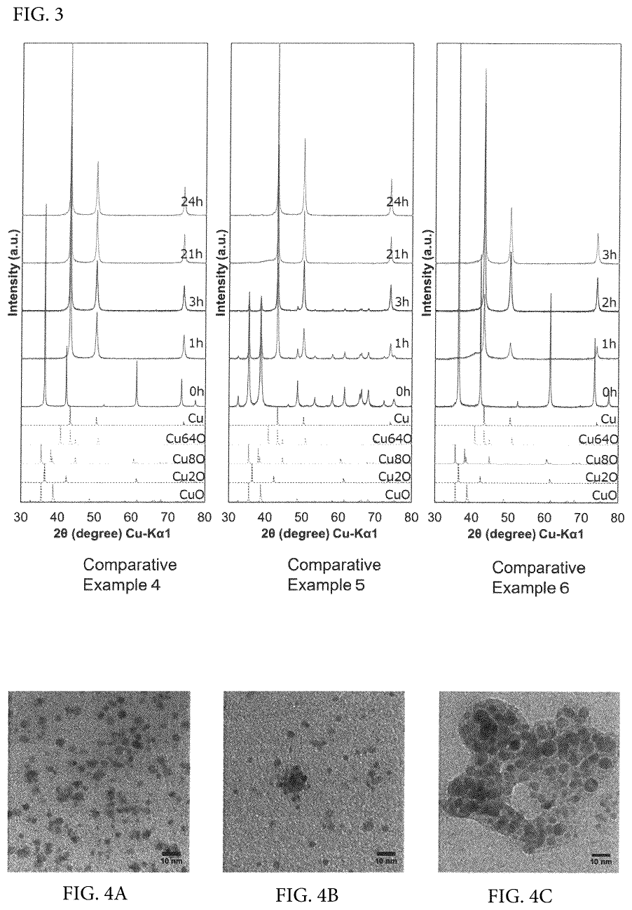

The slurry containing the product was subjected to X-ray diffraction measurement using a powder X-ray diffractometer (XRD, MiniFlex II manufactured by Rigaku Corporation, D/teX Ultra), obtaining XRD measurement results of the reaction process. For the measurement, Cu-Kα rays were used, and the scan speed was set to 20° min-1. The results are shown in FIG. 1 for Examples 1 to 3, FIG. 2 for Comparative Examples 1 to 3, and FIG. 3 for Comparative Examples 4 to 6. In the XRD measurement results of the reaction process, “0 h” indicates the time of the addition of the reducing agent, and for example, “1 h” indicates the measurement result after 1 hour from the addition of the reducing agent. In Comparative Examples 1 to 3 of FIG. 2, to observe the reaction process from copper (II) acetate, anhydrous as a starting material to Cu₆₄O and Cu₈O, XRD measurement results at 20=0 to 55° including 20=10° as a peak position of copper (II) acetate, anhydrous are shown, and in examples other than Comparative Example 1 to 3, in which the starting material was copper oxide, XRD measurement results at 20=30 to 80° are shown.

### (Electron Microscope Observation)

In the electron microscope observation, the obtained product was observed with a scanning electron microscope (SEM, JSM-6701F manufactured by JEOL Ltd., acceleration voltage: 15 kV) to obtain a SEM image, observed with a transmission electron microscope (TEM, JEM-2000FX manufactured by JEOL Ltd., acceleration voltage: 200 kV) to obtain a TEM image, and further observed with a scanning transmission electron microscope (STEM, JEM-ARM200 F, acceleration voltage: 200 kV) to obtain a STEM image. The observations with TEM and STEM were performed in a state where fine particles were dispersed so as not to be aggregated.

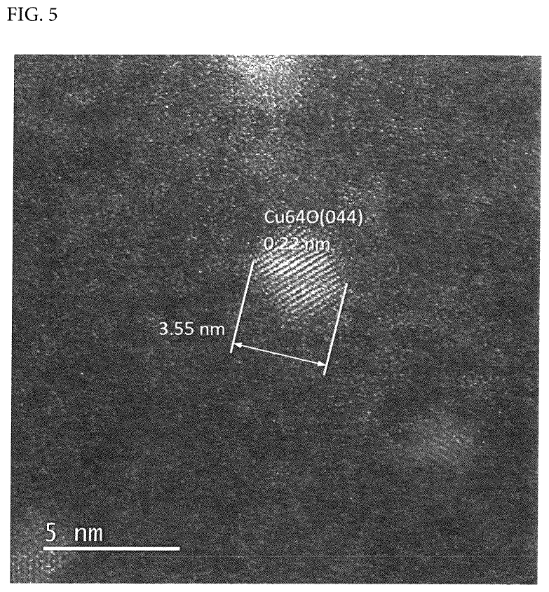

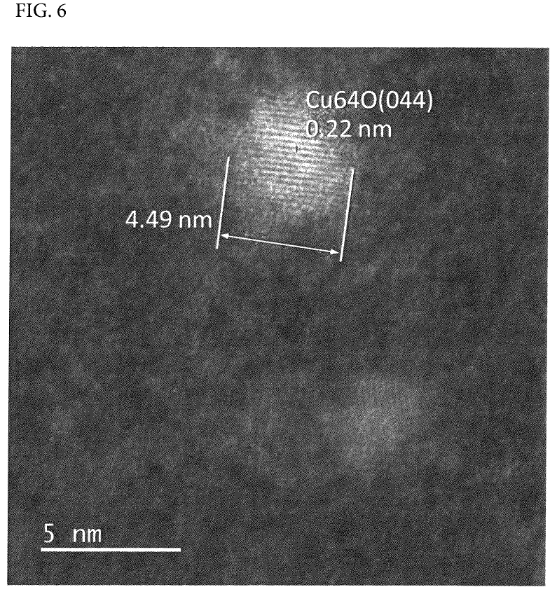

In the present production example, as a result of the electron microscope observation, TEM images of Examples 1 to 3 are shown in FIG. 4A to FIG. 4C, a STEM image of Example 1 (starting material was Cu₂O) is shown in FIG. 5, and a STEM image of Example 2 (starting material was CuO) is shown in FIG. 6.

The following is found from the above results. First, in Example 1 and Example 2, in which the starting material was in a copper 1 g scale with use of copper oxide raw material particles as a starting material and addition of acetic acid as a complexing agent, the TEM images of FIGS. 4A and 4B show that particles having a particle diameter of about 5 nm were formed, and the XRD pattern of FIG. 1 shows that these particles are particles containing Cu₆₄O and Cu₈O. From the STEM images of FIGS. 5 and 6, the presence of particles of around 4 nm having a crystal lattice corresponding to Cu₆₄O can be found. Also in Example 3, which is a scale of 100 times Example 1, it was confirmed from the TEM image of FIG. 4C and the XRD pattern of FIG. 1 that particles containing Cu₆₄O and Cu₈O approximately the same as those of Example 1 though including particles having a particle diameter of about 10 nm were obtained.

In contrast, as in Comparative Examples 1 to 3, when the starting material was copper (II) acetate, the XRD pattern shown in FIG. 2 shows that particles containing Cu₆₄O and Cu₈O were generated, but the weight and volume of the starting material were large, and a technique such as ultrasonic dispersion with manual stirring was required when the starting material was dissolved in a solvent, and therefore the mass productivity was poor. In these Comparative Examples, acetic acid as a complexing agent was not added, but water and acetic acid were released during the reaction process, so that it is considered that the same reaction as in Examples proceeded. On the other hand, in Comparative Examples 4 and 5, in which the starting material was copper oxide raw material particles and acetic acid as a complexing agent was not added, as shown in the XRD measurement results of the reaction process shown in FIG. 3, Cu₆₄O and Cu₈O were not observed, and the main product was metal copper. From these results, it has been found that acetic acid serving as a complexing agent is required for the generation of slightly oxidized copper-containing copper particles. In addition, a large number of white bright spots indicating the presence of copper clusters of about 0.2 nm were confirmed from the STEM dark field images shown in FIG. 5 and FIG. 6.

From the above findings, it was confirmed that desired particles including Cu₆₄O and Cu₈O and desired copper clusters were obtained by using copper oxide particles as a starting material and adding acetic acid as a complexing agent.

From the comparison between Example 1 and Example 2, owing to preferable use of Cu₂O as a starting material, a reaction quickly occurred, and the time required for the reaction was shortened. In the method using Cu₂O as a starting material, the raw material is reduced by 0.4 times in weight and by 0.125 times in bulk as compared with the conventional technique using copper (II) acetate as a starting material, and a step of dissolving copper (II) acetate in a solvent is unnecessary as a pre-step of a reaction, and handling of the raw material is easier, so that it can be said that the method is a production method particularly superior in mass productivity.

In Comparative Example 6, in which the reaction solution was not cooled, the solution temperature rose to 53.8° C. at the maximum in about 90 minutes from the start of the reaction. When 70 minutes had elapsed from the start of the reaction, the liquid temperature exceeded 50° C., and a glossy copper color began to be observed on the wall surface of the reaction vessel. As can be seen from the XRD pattern shown in FIG. 3, a peak of Cu₆₄O was observed in the initial stage of the reaction at the lapse of 1 hour, but no peak other than copper was observed at the lapse of 2 hours, and thus it was found that it was desirable to cool the reaction solution to 50° C. or lower.

### [2] Production Example According to Second Production Method

### (Preparation of Starting Material)

As copper oxide-coated metal copper raw material particles having different types of oxide films, copper particles TN-Cu100 (particle diameter: 50 to 200 nm) manufactured by Taiyo Nippon Sanso Corporation, acetic acid-coated copper particles (particle diameter: 50 to 200 nm), and copper particles 07439-01 (particle diameter: 1 to 10 μm) manufactured by Kanto Chemical Co., Inc. were used. These particles were used as starting materials as received or after being subjected to the oxidation treatment described later. The copper oxides formed on the surfaces of the starting materials were quantitatively measured by an RIR method of XRD. The results are shown in Table 2. The copper particles manufactured by Taiyo Nippon Sanso Corporation as the starting material of Example 4 are a commercially available product and are characterized by having a Cu₂O layer even in an initial state. It was confirmed that the Cu₂O layer accounted for 1.5% by mass.

The acetic acid-coated copper particles as the starting material of Example 5 were produced by a liquid phase reduction method in the following procedure. 1 mol of copper (II) oxide (NB-2 manufactured by Nissin Chemco Ltd.) as a raw material, 1 L of diethyleneglycol monoethyl ether (manufactured by Sankyo Chemical Co., Ltd.) as a solvent, and 60 mmol of acetic acid as a protective agent were added, and the temperature was raised to 70° C. Then, 2 mol of hydrazine monohydrate (manufactured by Kanto Chemical Co., Inc.) was added thereto, and the mixture was allowed to react for 1 hour while being stirred. After the reaction, purification was performed twice with acetone and twice with methanol, and a copper powder was obtained via vacuum drying. The resulting copper powder was subjected to an oxidation treatment in which the copper powder was exposed to air at room temperature for 44 hours, obtaining copper fine particles having 2.2% by mass of a Cu₂O layer as acetic acid-coated copper particles as the starting material of Example 5. It is considered that acetic acid is present on the surfaces of the acetic acid-coated copper particles because oxidation of copper on the surfaces is suppressed.

The copper particles manufactured by Kanto Chemical Co., Inc., which are the starting materials of Examples 6 to 8, are also commercially available, and in the initial state, no oxide was detected by XRD, but it is considered that the surfaces were slightly naturally oxidized. In Example 6, copper raw material particles whose surfaces were slightly naturally oxidized were used as a starting material. In Example 7, the powder of copper particles manufactured by Kanto Chemical Co., Inc. was placed in a thermo-hygrostat chamber maintained at 80° C. and 80% RH and exposed for 48 hours as an oxidation treatment, and then the resulting copper oxide-coated metallic copper raw material particles with 1.1% by mass of CuO layer formed were used as a starting material. Further, in Example 8, 0.5 mol of the copper particles manufactured by Kanto Chemical Co., Inc. were charged into 500 g of ultrapure water, and heated and boiled at 100° C. for 90 minutes as another oxidation treatment, and then the resulting copper oxide-coated metal copper raw material particles with 3.4% by mass of Cu₂₀ layer formed were used as a starting material.

### (Production of Core-Shell Fine Particles)

A reaction was carried out using the above-mentioned starting material and using a solvent, etc. in the addition amounts shown in Table 2. Specifically, ethylene glycol (manufactured by Kanto Chemical Co., Inc.) as a solvent, 1-amino-2-propanol (AmIP, manufactured by Kanto Chemical Co., Inc.) as an amine compound, and acetic acid (manufactured by Junsei Chemical Co., Ltd.) as a complexing agent were placed in a reaction vessel, sufficiently stirred, and then the starting material was added. While the reaction vessel was held in a water bath, hydrazine monohydrate (manufactured by Kanto Chemical Co., Inc.) was added as a reducing agent, and the mixture was allowed to react while being stirred at 1100 rpm. The reaction was carried out in air. After the reaction, purification by multiple centrifugations using N, N-dimethylacetamide, toluene, and hexane were performed, obtaining a slurry containing a product. As Comparative Examples, in Comparative Example 7, a slurry containing a product was obtained in the same manner as in Example 4 except that no complexing agent was added.

TABLE 2

| | | Quantified | | | | | | | | | | |
|---|---|---|---|---|---|---|---|---|---|---|---|---|
| | | value | | Addition amount | | | | | | RIR quantified value | | |
| | | of copper | Particle | Starting | | Acetic | | | | of product | | |
| | Copper | oxide | diameter | material | AmIP | acid | Hydrazine | EG | Cooling | Cu | Cu64O | Cu8O |
| No. | particles used | (wt %) | (μm) | (mmol) | (mmol) | (mmol) | (mmol) | (mmol) | method | (wt %) | (wt %) | (wt %) |
| Example 4 | Taiyo Nippon | 1.5 | 0.05 to 0.2 | 15.7 | 157 | 78.5 | 157 | 222.9 | Water | 39.1 | 53.2 | 7.6 |
| | Sanso | | | | | | | | bath | | | |
| | Corporation | | | | | | | | | | | |
| | TN-Cu100 | | | | | | | | | | | |
| Example 5 | Acetic acid- | 2.2 | 0.05 to 0.2 | 15.7 | 157 | 78.5 | 157 | 222.9 | Water | 42.0 | 53.6 | 4.5 |
| | coated copper | | | | | | | | bath | | | |
| | particles | | | | | | | | | | | |
| Example 6 | Kanto | N.D. | 1 to 10 | 15.7 | 157 | 235.5 | 157 | 78.5 | Water | 92.5 | 7.5 | N.D. |
| | Chemical Co., | | | | | | | | bath | | | |
| | Inc. 07439-01 | | | | | | | | | | | |
| Example 7 | Kanto | 1.1 | 1 to 10 | 15.7 | 157 | 78.5 | 157 | 222.9 | Water | 93.4 | 6.6 | N.D. |
| | Chemical Co., | | | | | | | | bath | | | |
| | Inc. 07439-01 | | | | | | | | | | | |
| Example 8 | Kanto | 3.4 | 1 to 10 | 15.7 | 157 | 78.5 | 157 | 222.9 | Water | 81.6 | 15.9 | 2.5 |
| | Chemical Co., | | | | | | | | bath | | | |
| | Inc. 07439-01 | | | | | | | | | | | |
| Comparative | Taiyo Nippon | 1.5 | 0.05 to 0.2 | 15.7 | 157 | 0 | 157 | 222.9 | Water | 100.0 | N.D. | N.D. |
| Example 7 | Sanso | | | | | | | | bath | | | |
| | Corporation | | | | | | | | | | | |
| | TN-Cu100 | | | | | | | | | | | |

*EG: ethylene glycol,
AmIP: 1-amino-2-propanol

### (X-Ray Diffraction Measurement)

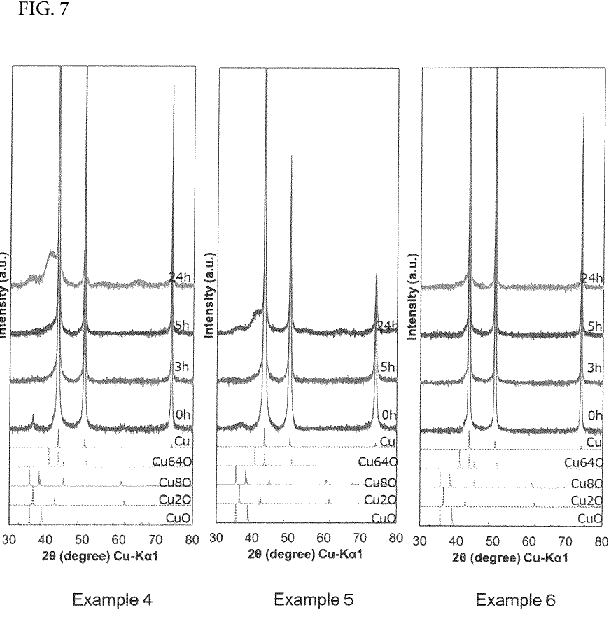

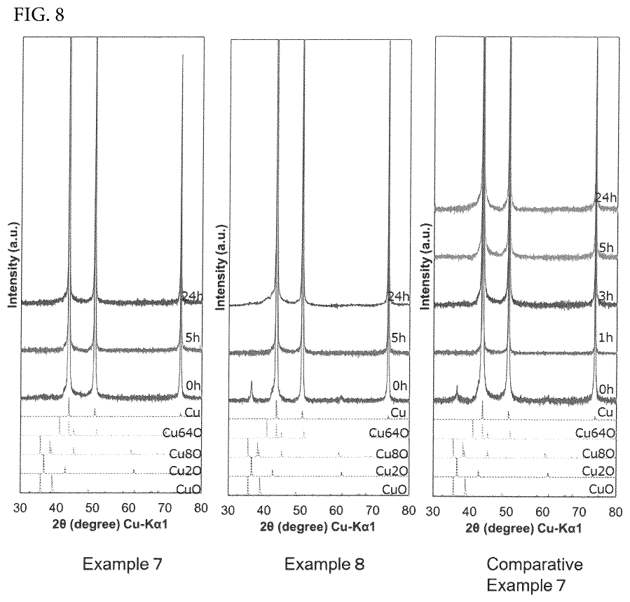

Using the slurry containing the product, X-ray diffraction measurement in the reaction process was performed in the same manner as in the above-described “[1] Production example according to first production method”. The results are shown in FIG. 7 for Examples 4 to 6, and in FIG. 8 for Examples 7 and 8 and Comparative Example 7.

### (Electron Microscope Observation)

Using the product obtained, SEM observation, TEM observation, and STEM observation were performed in the same manner as in the above-described “[1] Production example according to first production method”.

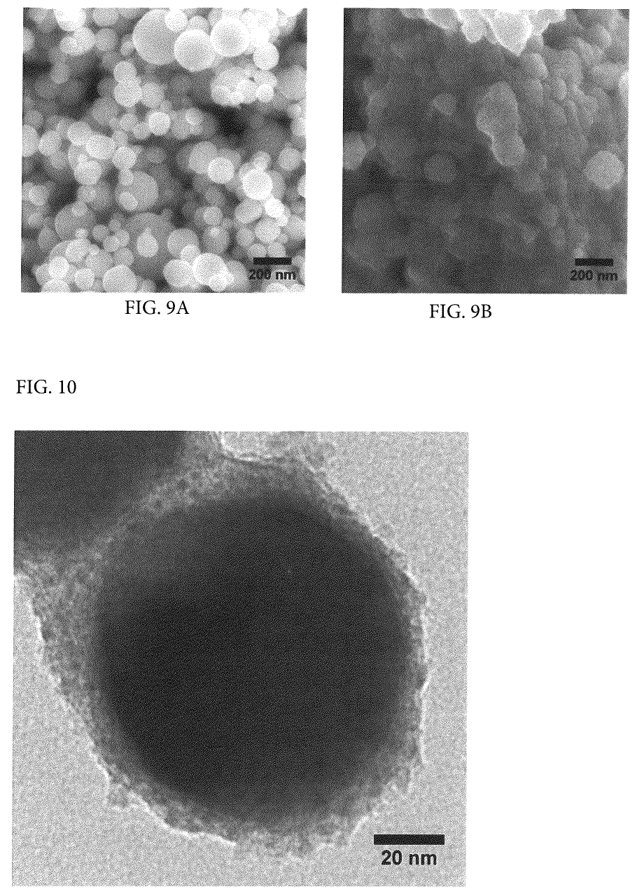

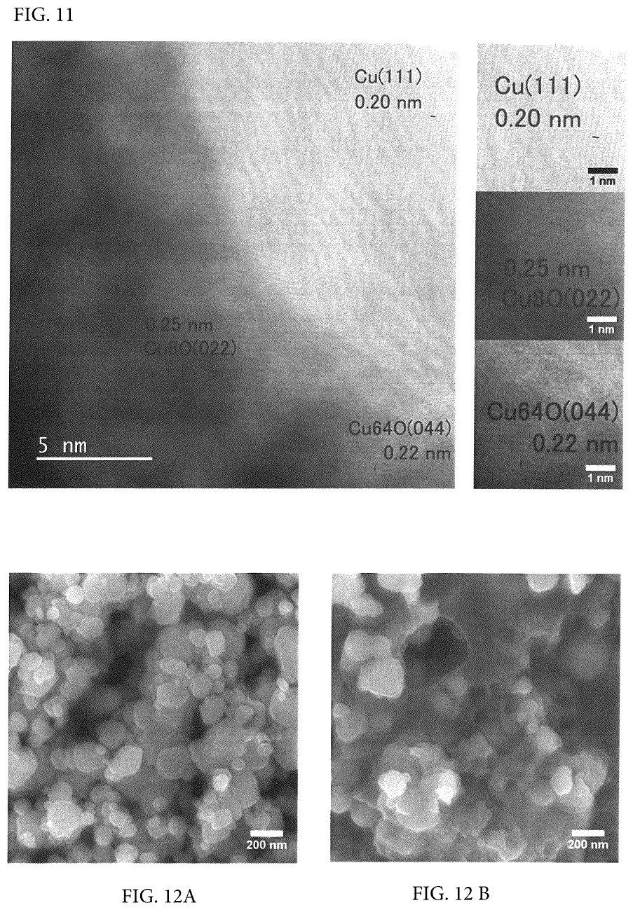

From the X-ray diffraction measurement and electron microscope observation, the following was confirmed for each example. First, regarding Example 4, it has been confirmed from the XRD pattern of the reaction process of FIG. 7 that in this example, in which copper particles having 1.5% by mass of an oxide film and having a particle diameter of 50 to 200 nm manufactured by Taiyo Nippon Sanso Corporation were used as a starting material and acetic acid was used, the generation of Cu₆₄O and Cu₈O was confirmed in addition to the presence of the copper of the starting material. FIG. 9A and FIG. 9B show the SEM images of the starting material of Example 4 and particles after the reaction for 24 hours. FIG. 9A shows the starting material, and FIG. 9B shows the particles after the reaction for 24 hours. From the comparison of these photographs, it has been confirmed that a substance seemed to be a slightly oxidized substance generated was attached around the copper raw material particles of the starting material via the reaction. A TEM image of a particle obtained in Example 4 is shown in FIG. 10. Further, STEM images of a particle obtained in Example 4 are shown in FIG. 11. From the TEM image of FIG. 10, the generated particles had a core-shell form, and it has been confirmed from the lattice plane spacing observed in the STEM images of FIG. 11 that the core portion was copper, and the surface of the core was covered in a shell form with nanoparticles containing Cu₆₄O and Cu₈O with a particle diameter of about 3 nm.

On the other hand, in Comparative Example 7, in which the reaction was carried out under the same conditions as in Example 4 except that acetic acid was not added, neither Cu₆₄O nor Cu₈O was detected, and the product was only metal copper. From this, it has been confirmed that acetic acid as a complexing agent was necessary for the generation of the oxide-containing particles according to the present embodiment.

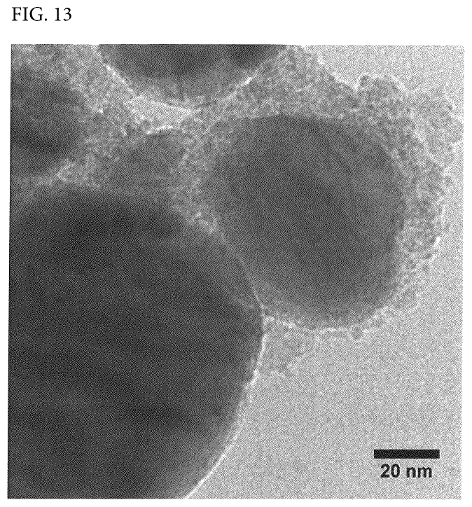

Next, regarding Example 5, it has been confirmed from the XRD pattern in the reaction process of FIG. 7 that also when copper oxide-coated metal copper raw material particles having 2.2% by mass of an oxide film were used as a starting material, Cu₆₄O and Cu₈O were generated in addition to the copper of the starting material as in Example 4. FIG. 12A and FIG. 12B show the SEM images of the starting material of Example 5 and particles after the reaction for 24 hours. FIG. 12A shows the starting material, and FIG. 12B shows the particles after the reaction for 24 hours. In addition, a TEM image of a particle obtained in Example 5 is shown in FIG. 13. From these SEM images and TEM images, it has also been confirmed that the surface of a core copper particle was covered in a shell form with nanoparticles containing Cu₆₄O and Cu₈O.

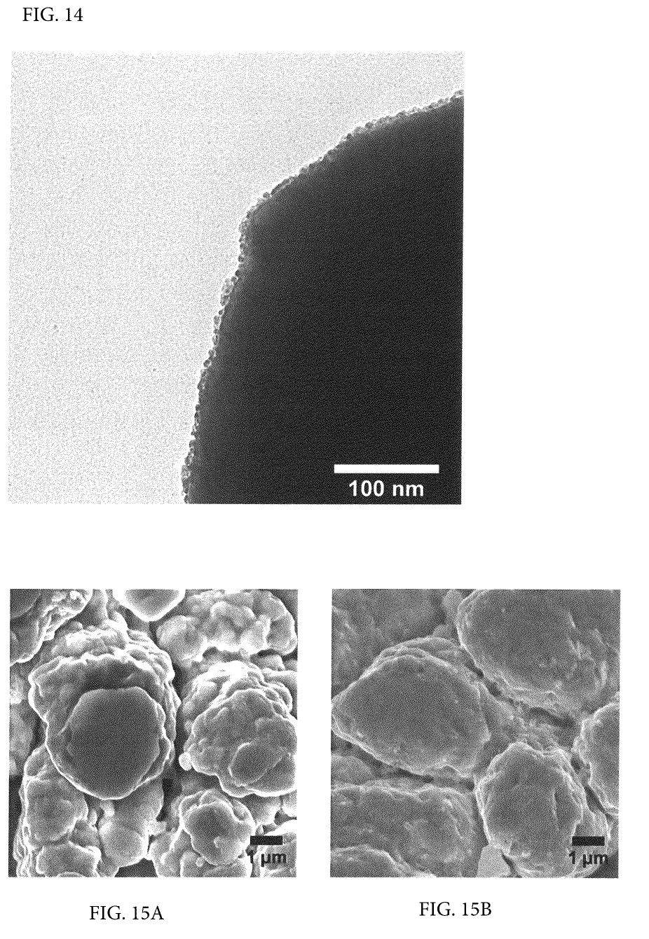

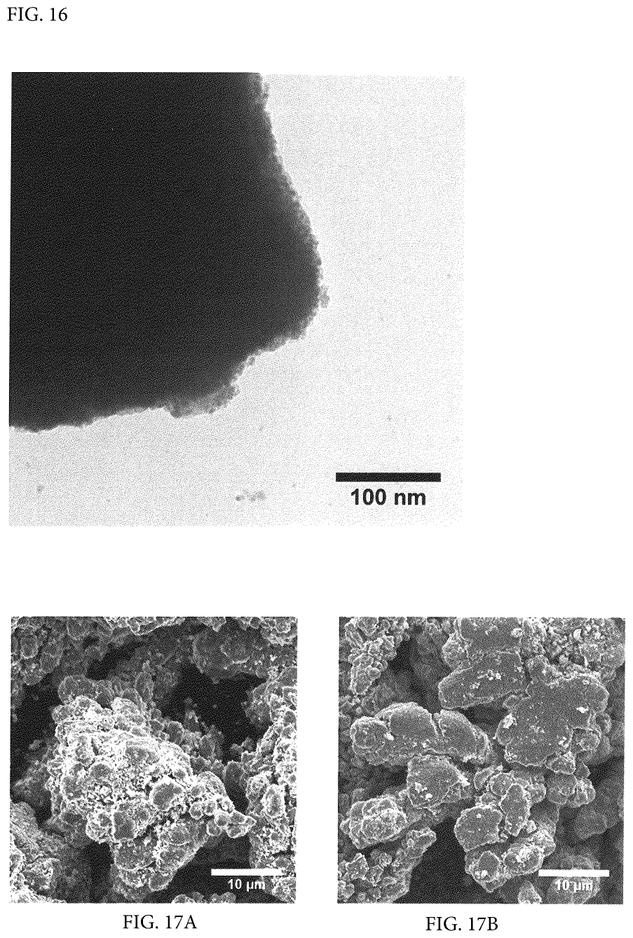

Examples 6 to 8 are examples in which copper particles manufactured by Kanto Chemical Co., Inc. were used, and it has been confirmed from the XRD patterns of the reaction processes in FIGS. 7 and 8 that Cu₆₄O and Cu₈O were generated regardless of whether or not the copper particles manufactured by Kanto Chemical Co., Inc., were subjected to an oxidation treatment. In addition, a TEM image of a particle obtained in Example 6 is shown in FIG. 14. FIG. 15A and FIG. 15B show the SEM images of the starting material of Example 7 and particles after the reaction for 24 hours. FIG. 15A shows the starting material, and FIG. 15B shows the particles after the reaction for 24 hours. A TEM image of a particle obtained in Example 7 is shown in FIG. 16. Further, FIG. 17A and FIG. 17B show the SEM images of the starting material of Example 8 and particles after the reaction for 24 hours. FIG. 17A shows the starting material, and FIG. 17B shows the particles after the reaction for 24 hours. As shown in FIGS. 14 to 17, it has been confirmed that the surface of a core copper particle was covered in a shell form with nanoparticles containing Cu₆₄O and Cu₈O.

From the above confirmations, the following can be stated. In view of the fact that Cu₆₄O and Cu₈O were efficiently generated from copper oxide in Examples 1 to 3 described above, to efficiently generate core-shell particles having a shell containing slightly oxidized copper, the starting material is preferably copper oxide-coated metal copper raw material particles having a surface oxide layer. Even in Example 6, in which there was a surface oxide layer as much as natural oxidation, which cannot be detected by XRD, the formation of a sufficient shell was confirmed from the TEM image shown in FIG. 14. This reveals that it is sufficient for the copper oxide film containing one or more of CuO and Cu₂O present on the surface of the starting material to be an oxide film at a degree as much as natural oxidation, which cannot be detected by X-ray diffraction. When it is desired to form a thick shell including slightly oxidized copper composed of one or more of Cu₆₄O and Cu₈O of the finally obtained core-shell type slightly oxidized copper-coated copper particles, slightly oxidized copper-coated copper particles with a thick shell are formed by means of use of starting material particles whose surfaces are actively oxidized as in Examples 5, 7, and 8.

In addition, in the RIR quantitative measurement results of the particles obtained in Examples 4 to 8, since the quantified values of Cu₆₄O and Cu₈O were larger than the amounts obtained from the amounts of oxides contained in the starting material, it has become clear that oxidation and complex formation of the metal copper particles as the starting material occurred in the reaction solution, and a reaction to generate Cu₆₄O and Cu₈O also occurred.

In core-shell particles having a slightly oxidized copper shell, when it is desired to form the shell to be thick with particles having a small core particle diameter and a large surface area ratio, the starting material needs to have more surface oxide layers, and it is desirable to have 1.5% by mass to 2.2% by mass of surface oxide layers as in Example 4 and Example 5.

From the findings described above, in the case of generating core-shell particles having a slightly oxidized copper shell, it has been confirmed that by using copper particles having one or more copper oxide films of Cu₂O and CuO as a starting material and adding acetic acid as a complexing agent, core-shell type slightly oxidized copper-coated copper fine particles having copper fine particles as a core and a shell composed of nanoparticles including Cu₆₄O and Cu₈O having a particle diameter of 20 nm or less are obtained. This method makes it possible to easily obtain core-shell type slightly oxidized copper-coated copper fine particles in which the surfaces of copper particles having a size of submicron to micron are covered with nanoparticles containing slightly oxidized copper, which cannot be obtained by a conventional mixing method.

In the method according to the present embodiment, not only submicron copper particles but also micron-order copper particles obtained a similar product, that is, core-shell type slightly oxidized copper-coated copper fine particles in which the surfaces of micron-order copper particles were covered with nanoparticles containing slightly oxidized copper were obtained. In addition, in the slightly oxidized copper-coated copper particles according to the present embodiment, since slightly oxidized copper particles are attached to copper particles as a core, there are advantages that the slightly oxidized copper-coated copper particles are easily sedimented and the particles are easily collected at the time of purification.

In the calcination of a copper paste containing the slightly oxidized copper-coated copper particles according to the present embodiment, the shell composed of nanoparticles of Cu₆₄O and Cu₈O is easily reduced to metal copper, and adjacent copper fine particle cores are closely connected to each other, whereby sintering between core particles is dramatically promoted. The resulting sintered compact is expected to have a structure in which copper fine particle cores having high crystallinity are densely connected, are superior in mechanical strength, and exhibit high electrical conductivity.

### [3] Another Production Example According to Second Production Method

### Example 4A

Example 4A is an example in which the synthesis scale of Example 4 was changed.

### (Production of Core-Shell Fine Particles)

The core-shell type slightly oxidized copper-coated copper fine particles to be used in the present Production Example were synthesized in the same manner as in Example 4 except that the addition amounts of a starting material, 1-amino-2-propanol (AmIP), acetic acid, hydrazine monohydrate, and ethylene glycol (EG) were each made 100 times, and a slurry containing slightly oxidized copper-coated copper fine particles as a product in hexane was obtained. The weight of the slightly oxidized copper-coated copper fine particles in the slurry was calculated in advance by the following formula (1).

$$[ Expression 1 ]$$

$$Y = \frac{{M}_{S} - {ρ}_{m} \times {V}_{S}}{1 - \frac{{ρ}_{m}}{{ρ}_{Cu}}} \qquad ( 1 )$$

In the formula (1),
Y: particle weight (g) in slurry
Mₛ: slurry weight (g)
Vₛ: slurry volume (cm³)
ρₘ: solvent density (g/cm³)
ρ_{Cu}: copper density (g/cm³).

### (Production of Paste Containing Core-Shell Fine Particles)

The solvent of the slurry containing the synthesized slightly oxidized copper-coated copper fine particles was replaced from hexane to ethanol by centrifugation. The resulting mixture was further centrifuged to remove the supernatant ethanol, thereby obtaining a wet cake of slightly oxidized copper-coated copper fine particles. 7.5 parts by weight of triethanolamine (manufactured by FUJIFILM Wako Pure Chemical Corporation) was added to 92.5 parts by weight (a value calculated by the formula (1)) of the slightly oxidized copper-coated copper fine particles in the wet cake. After the addition, the mixture was stirred for 4 minutes using a rotation and revolution mixer (AR-100 manufactured by THINKY Corporation, and then intermittently subjected to a dispersion treatment for 3 minutes using a thin-film spin system high-speed mixer (FILMIX 56-L manufactured by PRIMIX Corporation), obtaining a paste after the dispersion treatment. The resulting paste after the dispersion treatment was divided into portions, and different amounts of triethanolamine were further added to each portion to adjust the concentration, and each of the mixtures was stirred for 8 minutes using a rotation and revolution mixer. Thereafter, ethanol was removed by holding the mixtures in normal temperature vacuum until the weight no longer changed, whereby pastes of five levels differing in the concentration of slightly oxidized copper-coated copper fine particles were obtained.

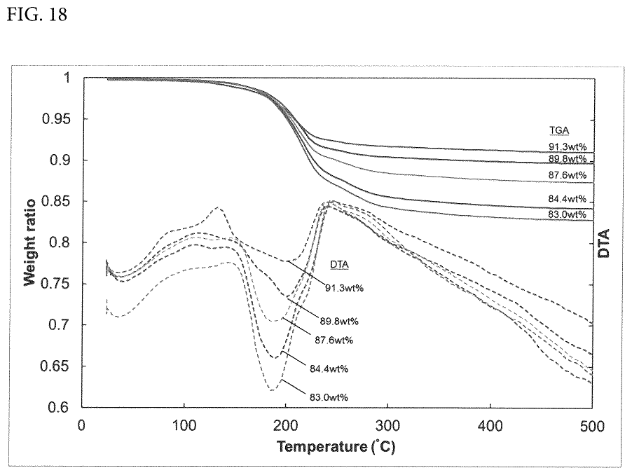

The pastes obtained were subjected to thermogravimetric/differential thermal analysis (TG-DTA) at a temperature raising rate of 5° C./min under a 3% hydrogen/nitrogen mixed gas using a TG/DTA simultaneous measuring instrument manufactured by Shimadzu Corporation. The results are shown in FIG. 18. From the weight loss indicated by the TGA in FIG. 18, it has been confirmed that the obtained pastes of five levels contained 91.3% by weight, 89.8% by weight, 87.6% by weight, 84.4% by weight, and 83.0% by weight of slightly oxidized copper-coated copper fine particles, respectively. Hereinafter, the concentration of the slightly oxidized copper-coated copper fine particles contained in a paste may be referred to as “paste concentration”.

### (Bonding Calcination Evaluation)

Two copper test pieces were bonded to each other using a paste obtained, then a sample for evaluation of bonding calcination was prepared via calcination of the paste, and then the bonding strength was measured.

### 1. Preparation of Sample for Evaluation of Bonding Calcination

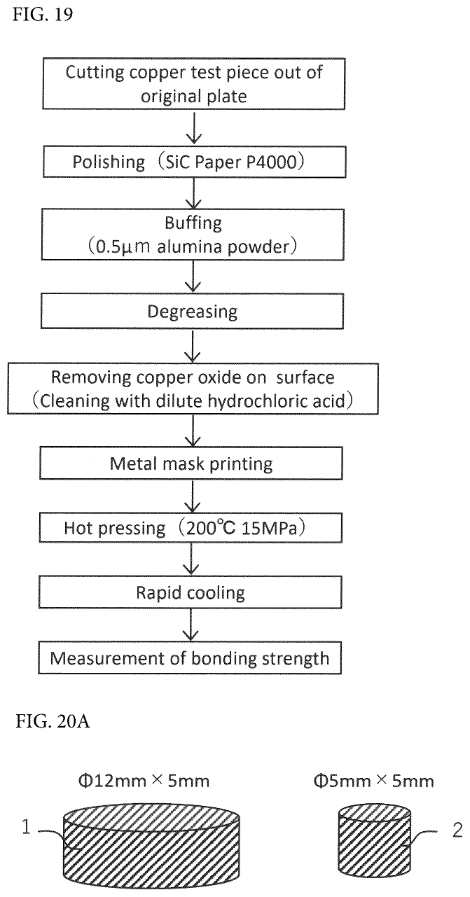

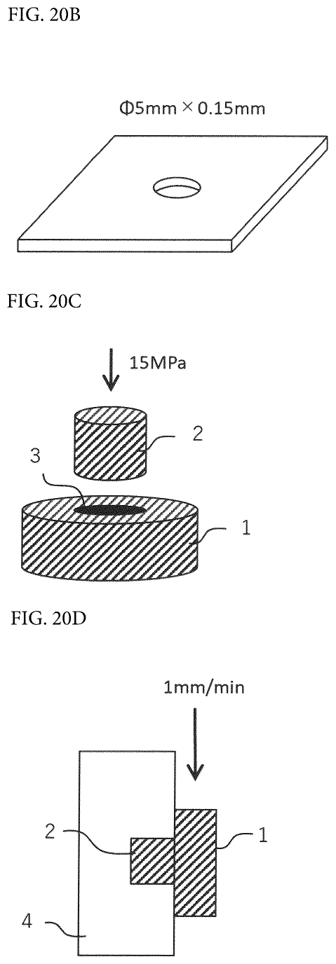

The procedure for preparing the sample for evaluation of bonding calcination is as shown in FIG. 19. First, a copper test piece 1 having a diameter of 12 mm and a copper test piece 2 having a diameter of 5 mm were cut as circular copper test pieces out of an oxygen-free copper plate (C1020P) having a thickness of 5 mm as shown in FIG. 20A. The surface of each of the copper test pieces was polished with a waterproof grinding and polishing paper (SiC Paper) P4000, then mirror-finished (buffed) with a polishing cloth soaked with a suspension of 0.5 μm alumina powder, and then degreased, whereby the copper test pieces were finished. Before applying the paste, each copper test piece was immersed in 2.5M hydrochloric acid to remove a copper oxide film on the surface, sufficiently washed with pure water and methanol, and then dried.

Subsequently, metal mask printing was performed. Specifically, using a metal mask with an opening having a size of 5 mm in diameter×0.15 mm in thickness schematically depicted in FIG. 20B, the paste (paste containing 91.3% by weight of slightly oxidized copper-coated copper fine particles) 3 was applied to the center of a copper test piece 1 having a diameter of 12 mm as shown in FIG. 20C, and the copper test piece 1 was bonded to a copper test piece 2 having a diameter of 5 mm. Thereafter, a load of 15 MPa was applied in the direction arrowed in FIG. 20C by hot pressing to the two copper test pieces bonded together, the temperature was raised at a high speed up to 200° C. at 90° C./min, and the paste was calcined while the temperature was retained after reaching 200° C. The retaining time from reaching 200° C. was set four steps, namely, 1 minute, 5 minutes, 10 minutes, and 15 minutes. After holding at 200° C., the resulting assembly was taken out from the hot press and rapidly cooled to normal temperature, obtaining a sample for evaluation of bonding calcination in which the copper test pieces were bonded to each other by a sintered product formed by calcination of the paste. The series of operations from the metal mask printing to the calcination and rapid cooling to room temperature was performed in a nitrogen atmosphere.

### 2. Bonding Calcination Evaluation Test (Measurement of Bonding Strength)

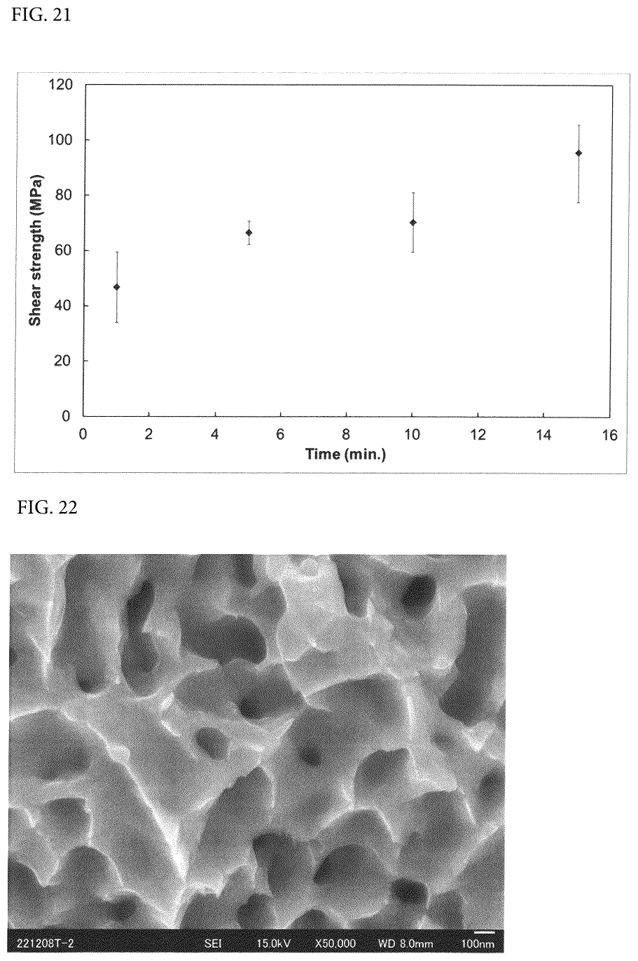

The bonding strength of the sample for evaluation of bonding calcination was evaluated using a 5 kN material tester (manufactured by Shimadzu Corporation). Specifically, as shown in a schematic sectional view in FIG. 20D, a load was applied to the sample for evaluation of bonding calcination fixed to a fixing jig 4 of the tester in parallel with the coated surface at a speed of 1 mm/min, and the breaking load of the copper test pieces was measured as the bonding strength. The results are shown in FIG. 21 as a graph showing the relationship between the retaining time (bonding time) from the reaching 200° C. and the breaking load (bonding strength). The vertical width indicated in each measured value in FIG. 21 indicates variation among two to four measurements. As shown in FIG. 21, extremely high bonding strength of 66 MPa or more was obtained when the bonding time was 5 minutes or more, and a sufficient bonding strength of 47 MPa was obtained even when the bonding time was 1 minute.

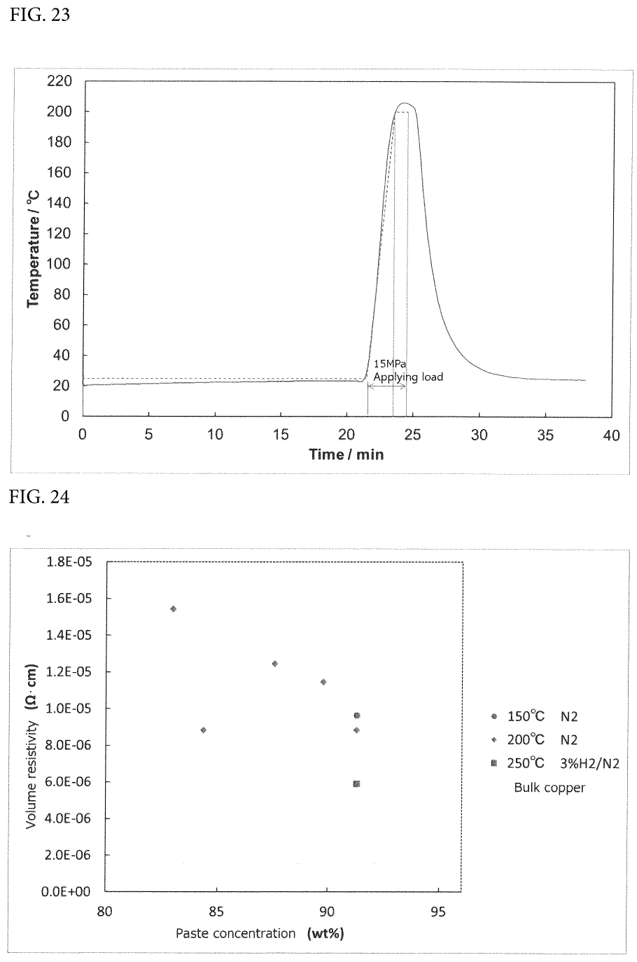

FIG. 22 shows a SEM image of the fracture surface after the test of the sample for evaluation of bonding calcination for a bonding time of 1 minute. It has been confirmed from FIG. 22 that the particles were densely sintered. A temperature profile in hot pressing when the bonding time was 1 minute is shown in FIG. 23. As shown in FIG. 23, in the case of the bonding time of 1 minute, it can be seen that the bonding step is a step in which the time from the start of heating to the cooling is as short as about 8 minutes. It has been demonstrated that any paste containing the slightly oxidized copper-coated copper fine particles of the present embodiment can provide a calcined product that is firmly sintered even in an extremely short time as described above.

### (Evaluation of Conductivity (Electrical Conductivity))

An alumina plate (AO-5050 manufactured by Furuuchi Chemical Corporation) having a thickness of 1 mm was cut out into a size of 5 cm×2.5 cm, obtaining a substrate to be used for evaluation. To the surface of the substrate, the pastes of the above-described five levels differing in the concentration of the slightly oxidized copper-coated copper fine particles (paste concentration) each in a range of 2 cm in width and 4 cm in length with a doctor blade (manufactured by Imoto machinery Co., Ltd.) having an application width of 2 cm and an application thickness of 10 μm. This was placed in a tubular furnace, a nitrogen gas or a 3% hydrogen/nitrogen mixed gas was supplied into the tube at a flow rate of 1 L/min, and gas replacement was performed at normal temperature for 30 minutes or more. Thereafter, while nitrogen gas or the 3% hydrogen/nitrogen mixed gas was supplied into the tube at a flow rate of 1 L/min, the temperature was raised to an evaluation temperature of 200° C. in about 20 minutes, held at the evaluation temperature of 200° C. for 1 hour, and then naturally cooled to normal temperature, obtaining the substrate with the paste calcined. When the paste concentration was 91.3% by weight, the evaluation temperature was set to three levels of 150° C., 200° C., and 250° C. The paste that was brownish at the time of the application changed to reddish brown after the calcination. The series of operations from the application of the paste to natural cooling to normal temperature while holding the evaluation temperature was performed in a nitrogen atmosphere.

The conductivity of the calcined product was measured using a resistivity meter (Loresta-GP, ASP probe manufactured by Mitsubishi Chemical Analytech Co., Ltd.). FIG. 24 shows a graph showing the relationship between the paste concentration and the volume resistivity for each evaluation temperature together with the volume resistivity of bulk copper. From FIG. 24, the volume resistivity of the product calcined using the paste having a paste concentration of 91.3% by weight was 6×10⁻⁶ Ωcm, which was on the same order as the resistivity of bulk copper at 0° C. (namely, 1.55×10⁻⁶ Ωcm), and was an extremely good value. In the measurement of the volume resistivity, a value calculated by Loresta-GP was used as the resistivity correction factor RCF for correcting the shape factor of the coating film, and the film thickness of the calcined product was calculated from an image obtained by observing a section formed by breaking the calcined substrate, with a microscope (digital microscope VHX-7000 manufactured by KEYENCE Corporation).

### (X-Ray Diffraction Measurement) (XRD Measurement Results Before and After Calcination)

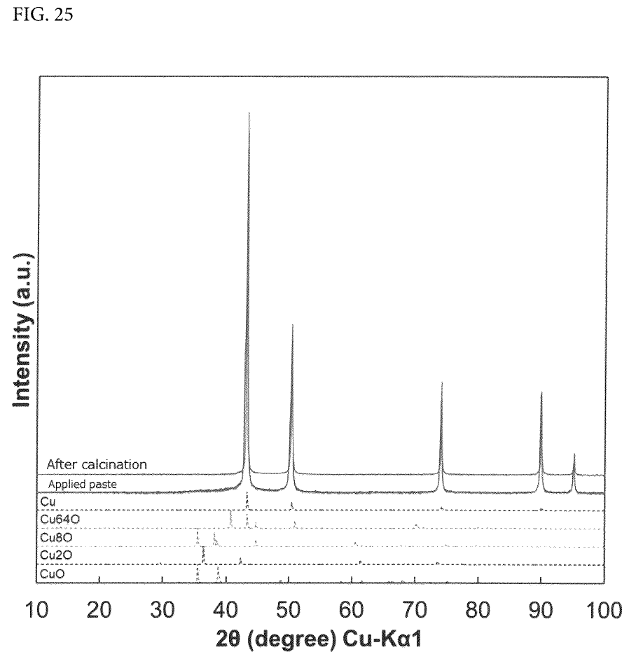

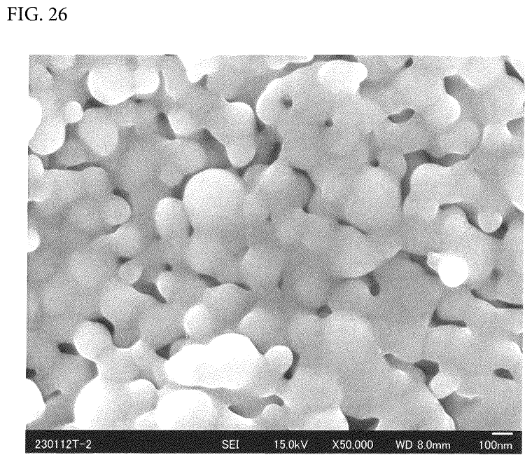

X-ray diffraction measurement before and after calcination of the paste was performed using a powder X-ray diffractometer (XRD, MiniFlex II manufactured by Rigaku Corporation, D/teX Ultra), and the XRD measurement results of the reaction process when the calcination was performed at 250° C. under a 3% hydrogen/nitrogen mixed gas were obtained. The results are shown in FIG. 25. As shown in FIG. 25, the broad peaks of Cu₆₄O and Cu₈O observed with the applied paste before the calcination disappeared after the calcination due to reduction, and only sharp peaks derived from copper were confirmed. FIG. 26 is a SEM image of the calcined product calcined at 250° C. under a 3% hydrogen/nitrogen mixed gas. From the photograph of FIG. 26, it has been confirmed that a calcined product in which particles were densely sintered was obtained. Since Cu₆₄O and Cu₈O are nano-sized particles and formed in a shell form on the surfaces of copper particles, it has been suggested that adjacent copper particles were efficiently sintered due to a melting point drop in the process of reducing those particles, and it has been proved that the slightly oxidized copper-coated copper fine particles of the present embodiment had high sinterability.

### [4] Another Production Example According to Second Production Method

### Example 9

### (Preparation of Copper Powder)

Hexanoic acid-coated copper particles (particle diameter: 30 to 100 nm) were used as metal copper particles as a starting material. The hexanoic acid-coated copper particles were produced by a liquid phase reduction method in the following procedure. 1 mol of copper (II) oxide (NB-2 manufactured by Nissin Chemco Ltd.) as a raw material, 1 L of ethanol (manufactured by Japan Alcohol Trading Co., Ltd.) as a solvent, and 60 mmol of hexanoic acid as a protective agent were added, and the temperature was raised to 70° C. Then, 2 mol of hydrazine monohydrate (manufactured by Kanto Chemical Co., Inc.) was added thereto, and the mixture was allowed to react for 1 hour while being stirred. After the reaction, purification was performed twice with acetone and twice with methanol, and a copper powder was obtained via vacuum drying.

### (Addition of Copper Oxide Powder and Production of Core-Shell Fine Particles)

The addition of a copper oxide powder to a copper powder and the generation of core-shell particles were performed in the following procedure. 222.9 mmol of ethylene glycol (manufactured by Kanto Chemical Co., Inc.) as a solvent, 157 mmol of 1-amino-2-propanol (AmIP, manufactured by Kanto Chemical Co., Inc.) as an amine compound, and 78.5 mmol of acetic acid (manufactured by Junsei Chemical Co., Ltd.) as a complexing agent were placed in a reaction vessel, sufficiently stirred, and then 15.7 mmol (0.998 g) of hexanoic acid-coated copper particles as a starting material and 0.367 mmol (0.0525 g) of copper (I) oxide (Cu₂O, manufactured by Furukawa Chemicals Co., Ltd., particle diameter: 0.5 to 10 μm) as an additive were added. The addition amount of the copper (I) oxide with respect to the starting materials (the total amount of the metal copper and the copper oxide) was 5% by mass. While the reaction vessel was held in a water bath, hydrazine monohydrate (manufactured by Kanto Chemical Co., Inc.) was added as a reducing agent, and the mixture was allowed to react while being stirred at 1100 rpm. The reaction was carried out in air. After the reaction, purification by multiple centrifugations using N, N-dimethylacetamide, toluene, and hexane were performed, obtaining a slurry containing a product.

### (X-Ray Diffraction Measurement)

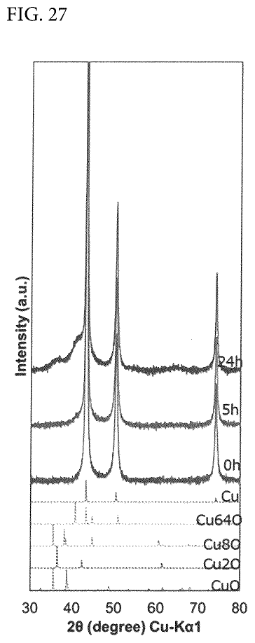

Using the product obtained, X-ray diffraction measurement was performed in the same manner as in the above-described “[1] Production example according to first production method”. The results are shown in FIG. 27.

### (Electron Microscope Observation)

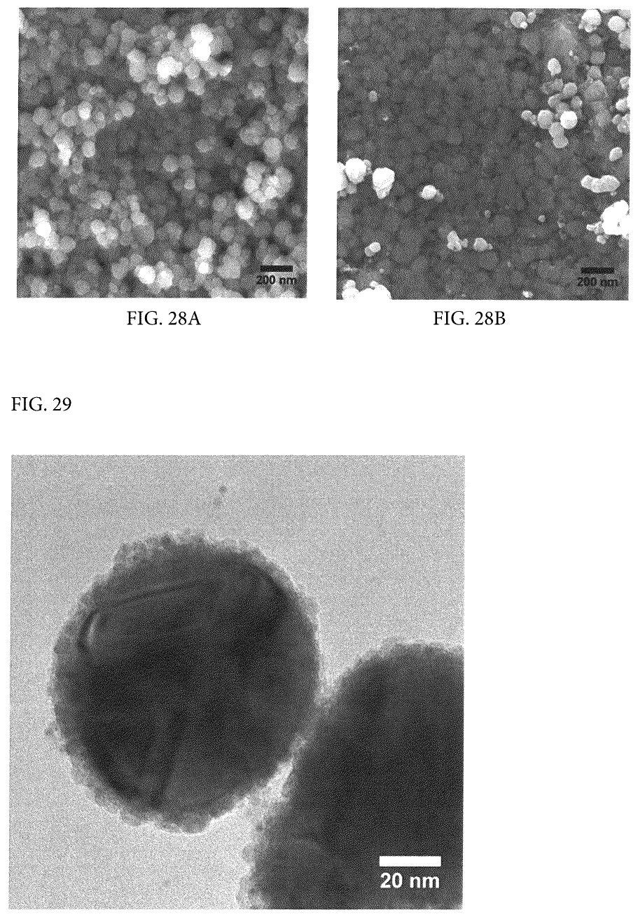

Using the product obtained, SEM observation and TEM observation were performed in the same manner as in the above-described “[1] Production example according to first production method”. As a result, SEM images are shown in FIG. 28. FIG. 28A shows the starting material, and FIG. 28B shows the particles after the reaction for 24 hours. In addition, a TEM image is shown in FIG. 29.

From the XRD patterns of the reaction process shown in FIG. 27, the generation of Cu₆₄O and Cu₈O in addition to copper was confirmed. From the comparison of the SEM images of A (the starting material) and B (after the reaction for 24 hours) shown in FIG. 28, it has been confirmed that a substance that seems to be a slightly oxidized substance such as Cu₆₄O or Cu₈O generated via the reaction around the copper particles of the starting material was attached. In addition, it has been confirmed from the TEM image of FIG. 29 that the surface of a core copper particle was covered in a shell form with nanoparticles containing Cu₆₄O and Cu₈O.

In the above-described “[2] Production example according to second production method”, copper particles having a surface oxide layer were used as a starting material. From the results described above, however, it has been confirmed that also when copper oxide particles were separately added as a starting material to copper particles as a core, core-shell type slightly oxidized copper-coated copper fine particles each having a copper fine particle as a core and a shell composed of nanoparticles containing Cu₆₄O and Cu₈O having a particle diameter of 20 nm or less were obtained. In Example 9, copper oxide particles were used as an additive, but it is considered that any substance that forms copper complex ions in a reaction solution similarly makes a reaction into Cu₆₄O and Cu₈O proceed. Therefore, even when the compound to be added to core particles is not copper oxide but a copper complex salt or the like, it is possible to obtain the same effect.

### INDUSTRIAL APPLICABILITY

The slightly oxidized copper-containing particles according to the present embodiment are sufficiently sintered even at a relatively low temperature of 200° C. or lower under normal pressure (or a pressure higher than or equal to normal pressure), and a sintered compact that exhibits sufficient electrical conductivity is obtained therefrom. Therefore, the slightly oxidized copper-containing particle according to the present embodiment can be used, for example, as a circuit forming material of a printed circuit board (especially, a flexible substrate) and other fine wiring materials, as well as a die bonding material of a power semiconductor for heat conduction applications. Further, the oxide-containing copper fine particles can also be used as an antistatic material, an electromagnetic wave shielding material, an infrared shielding material, or the like.

### REFERENCE SIGNS LIST

1, 2 Copper test piece
3 Paste containing slightly oxidized copper-coated copper fine particles
4 Fixing jig of testing machine

1. A production method for slightly oxidized copper-containing particles having, at least on surfaces thereof, slightly oxidized copper composed of one or more of Cu₆₄O and Cu₈O, the method comprising:
preparing raw material particles having, at least on a surface thereof, a copper oxide including one or more of CuO and Cu₂O; and
mixing the raw material particles with a solution containing an amine compound and a complexing agent, then adding a reducing agent, and allowing the resultant to react in an oxygen-containing atmosphere.

2. The production method according to claim 1, wherein the raw material particles are raw material particles made of a copper oxide including one or more of CuO and Cu₂O.

3. The production method according to claim 1, wherein the raw material particles are copper oxide-coated copper raw material particles each having a copper raw material particle as a core and a copper oxide film containing one or more of CuO and Cu₂O as a shell.

4. The production method according to claim 1, wherein the copper oxide contained in the raw material particles is Cu₂O.

5. The production method according to claim 1, wherein the complexing agent is a carboxylic acid.

6. The production method according to claim 1, wherein the complexing agent is acetic acid.

7. The production method according to claim 1, wherein the reaction is performed at 50° C. or lower.

8. The production method according to claim 1, wherein the raw material particles have an average particle diameter of more than 20 nm and not more than 10 μm.

9. A slightly oxidized copper-coated copper particles each comprising: a copper particle as a core; and a shell including slightly oxidized copper composed of one or more of Cu₆₄O and Cu₈O, wherein the slightly oxidized copper composed of one or more of Cu₆₄O and Cu₈O is in the form of slightly oxidized copper particles having an average particle diameter of more than 1 nm and not more than 20 nm.

10. (canceled)

11. The slightly oxidized copper-coated copper particles according to claim 9, wherein the copper particles as cores have an average particle diameter of more than 20 nm and not more than 2 μm.

12. A bonding material comprising the slightly oxidized copper-coated copper particles according to claim 9.

13. A paste comprising the slightly oxidized copper-coated copper particles according to claim 9.

14. An ink comprising the slightly oxidized copper-coated copper particles according to claim 9.

15. A production method for a bonded body using the slightly oxidized copper-coated copper particles according to claim 9.

16. A production method for a sintered compact using the slightly oxidized copper-coated copper particles according to claim 9.
